(19) United States
(12) Patent Application Publication
(10) Pub. No.: US 2009/0102426 A1
(43) Pub. Date: Apr. 23, 2009

(54) CHARGING SYSTEM AND METHOD FOR ELECTRONIC DEVICE

(75) Inventors: Juen Liou, Tianjin (CN); Tom Chen, Taipei (TW); Win-Harn Liu, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 11/877,215

(22) Filed: Oct. 23, 2007

(51) Int. Cl. H02J 7/00; H01M 10/44

(52) U.S. Cl. 320/137

(57) ABSTRACT

A charging system and method for an electronic device are used for controlling an external charging power supply to charge the electronic device. Electric quantity detection software running on the electronic device is used to detect electric quantity of a battery of the electronic device and to generate a signal indicating a message of performing a charging operation or indicating a message of stopping the charging operation. A Universal Serial Bus (USB) interface is disposed in the electronic device to output the signal. A USB control chip, disposed in a charging device, receives the signal and controls a switch to turn on or turn off the external charging power supply to charge or stop charging the electronic device. The charging system and method for an electronic device can effectively control the electric quantity of the battery of the electronic device without requiring a charging control circuit.

### BACKGROUND OF THE INVENTION

1. Field of the Invention

The present invention relates to a charging system and method for an electronic device. More particularly, the present invention relates to a charging system and method, capable of charging an electronic device through an external charging power supply controlled by a Universal Serial Bus (USB) interface of the electronic device.

2. Related Art

In order to enable consumers to boot the electronic device for a test before purchasing, the manufacturer makes the electronic devices be charged during the warm-up test on the electronic device before the electronic devices are shipped off the production line. The charging percentage is determined according to specifications of the manufacturers.

It is an urgent problem to be solved by the manufacturer how to control the charging amount and the charging time of the electronic device. An electric quantity control circuit is disposed in an early electronic device, which automatically detects the electric quantity of the battery to control the charging operation or to stop the charging operation, according to an initially set electric quantity specification, in the stage of the warm-up test on the production line. As the competition on the market environment becomes more and more vigorous and the price of the product decreases continuously, each manufacture must face the problem of saving the cost and reducing expenditures. In order to save the cost, currently, most of the manufacturers omit the electric quantity control circuit. However, on the other aspect, before the electronic devices are shipped off the production line, it cannot effectively control the electrically amount of the electronic device within a scope of specified specification. Alternatively, in order to control the electric quantity of the electronic device, it switches to charge and test the electronic devices through a manual way, which brings an additional cost. In addition, if the battery is over charged when the electronic device leaves factory, for example, being charged to be higher than 90%, the lifespan of the battery is affected.

Therefore, a method of controlling the electric quantity of the electronic devices during the warm-up process on the production line is desired, so as to reduce the cost and to effectively control the electric quantity of the electronic devices within a scope of specified specification before the electronic devices are shipped off the production line.

### SUMMARY OF THE INVENTION

In view of the above problem, the present invention is directed to a charging system and method for an electronic device, which are capable of reducing the cost and controlling the electric quantity of a battery of the electronic device within a scope of stipulated specifications before the electronic device is shipped off the production line.

The charging system for an electronic device in the present invention is used to control an external charging power supply to charge the electronic device, which includes: electric quantity detection software, a Universal Serial Bus (USB) interface, and a charging device. The electric quantity detection software runs on the electronic device, for generating a first signal indicating a message of performing a charging operation when the electric quantity of the battery of the electronic device is detected to be lower than a first amount, or for generating a second signal indicating a message of stopping the charging operation when the electric quantity is higher than a second amount; the USB interface is disposed in the electronic device, for outputting the first signal or the second signal; the charging device is connected to the USB interface, and has a USB control chip and a switch. The USB control chip is used to receive the first signal and to control the switch to turn on an external charging power supply to charge the electronic device; or to receive the second signal and to control the switch to turn off the external charging power supply to stop charging the electronic device.

The charging method for an electronic device in the present invention includes the following steps. Electric quantity detection software running on the electronic device is used to detect the electric quantity of a battery of the electronic device; when the electric quantity of the battery is detected to be lower than a first amount, a first signal indicating a message of performing a charging operation is transmitted through a USB interface; when the electric quantity of the battery is detected to be higher than a second amount, a second signal indicating a message of stopping the charging operation is transmitted through the USB interface; a USB control chip disposed in a charging device is used to receive the first signal and to control an external charging power supply to perform the charging operation, and to receive the second signal and to control the external charging power supply to stop the charging operation.

The present invention outputs a signal current indicating a message of performing a charging operation or indicating a message of stopping the charging operation through the USB interface of the electronic device, and uses the USB control chip disposed in the charging device to receive the signal, so as to control the switch to turn on or turn off the external charging power supply to charge or to stop charging the electronic device. The charging system and method for an electronic device in the present invention can effectively control the electric quantity of the electronic device, without requiring a charging control circuit in the electronic device. Furthermore, the charging system and method of the present invention can be repeatedly used in electronic devices where the USB interfaces are applicable for, so the cost is reduced.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a charging system for an electronic device according to the present invention; and

FIG. 2 is a flow chart of the charging method for the electronic device according to the present invention.

### DETAILED DESCRIPTION OF THE INVENTION

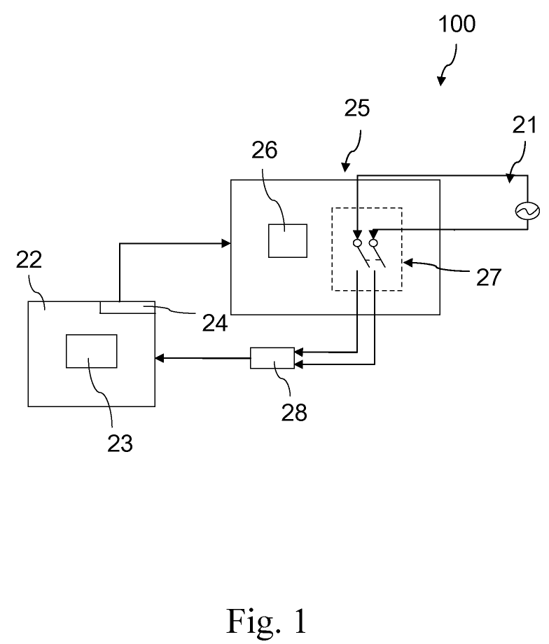

Referring to FIG. 1, it is a schematic view of a charging system for an electronic device according to the present invention. As shown in FIG. 1, the charging system 100 for an electronic device is used to control an external charging power supply 21 to charge an electronic device 22. The charging system 100 for an electronic device includes electric quantity detection software 23, a Universal Serial Bus (USB) interface 24, and a charging device 25.

The electric quantity detection software 23 runs on the electronic device 22, for generating a first signal indicating a message of performing a charging operation when the electric quantity of a battery of the electronic device 22 is detected to be lower than a first amount, or generating a second signal indicating a message of stopping the charging operation when the electric quantity of the battery is detected to be higher than a second amount. The electronic device is an electronic device with a USB interface, such as a notebook computer, a portable computer, a mobile phone, a MPEG Audio Layer 3 (MP3) player or a MPEG 4 (MP4) player. The first amount of the electric quantity ranges from 10% to 40%. For example, the first amount may be 10%, 25% or 40%. The second amount of the electric quantity ranges from 60% to 90%. For example, the second amount may be 60%, 75% or 90%.

The USB interface 24 is disposed in the electronic device 22, so as to output the first signal or the second signal.

The charging device 25 is connected to the USB interface 24, and has a USB control chip 26 and a switch 27. The USB control chip 26 is used to receive the first signal and to control the switch 27 to turn on the external charging power supply 21 to charge the electronic device 22, or to receive the second signal and to control the switch 27 to turn off the external charging power supply 21 to stop charging the electronic device 22.

Once the external charging power supply 21 is turned on by the switch 27, an adaptor 28 is firstly used to convert an alternating current (AC) into a direct current (DC), so as to charge the electronic device 22.

The electric quantity detection software 23 running on the electronic device 22 is used to detect the electric quantity of the battery of the electronic device 22, for generating the first signal indicating a message of performing a charging operation when the electric quantity of the battery is detected to be lower than the first amount, or generating the second signal indicating a message of stopping the charging operation when the electric quantity of the battery is detected to be higher than the second amount. The electric quantity detection software 23 outputs the first signal or the second signal through the USB interface 24 of the electronic device 22. The USB control chip 26 of the charging device 25 receives and processes the first signal or the second signal, so as to determine the electric quantity detection software 23 intends to perform the charging operation or to stop the charging operation. When the USB control chip 26 receives the first signal indicating a message of performing a charging operation, the USB control chip 26 controls the switch 27 to turn on the external charging power supply 21 to charge the electronic device 22; or when the USB control chip 26 receives the second signal indicating a message of stopping the charging operation, the USB control chip 26 controls the switch 27 to turn off the external charging power supply 21 to stop charging the electronic device 22.

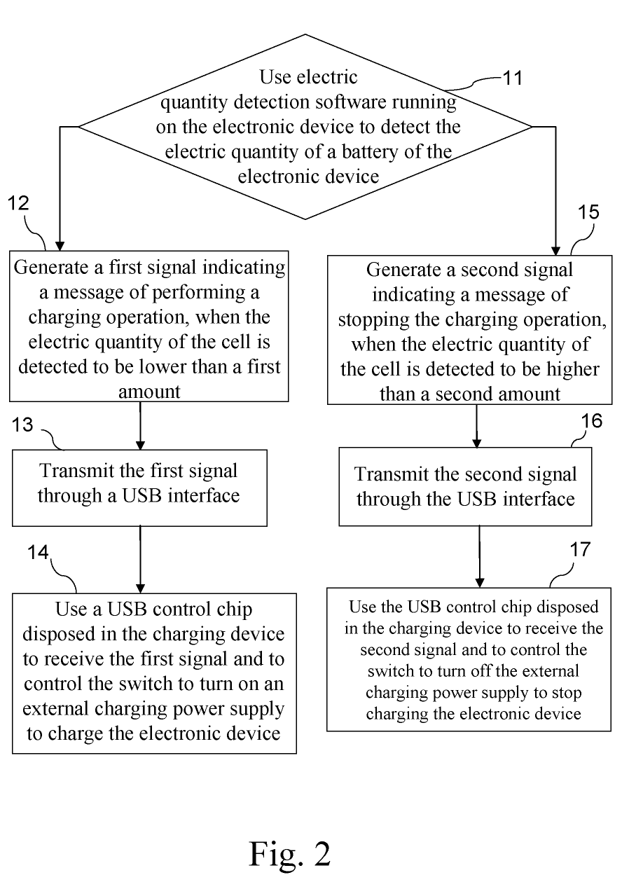

Referring to FIG. 2, it is a flow chart of the charging method for the electronic device according to the present invention. The charging method for an electronic device in the present invention is used to control an external charging power supply to charge or to stop charging the electronic device, which includes the following steps. Firstly, electric quantity detection software running on the electronic device is used to detect the electric quantity of a battery of the electronic device (Step 11). Next, when the electric quantity of the battery is detected to be lower than a first amount, a first signal indicating a message of performing a charging operation is generated (Step 12). Then, the first signal is transmitted through a USB interface (Step 13). Then, a USB control chip disposed in the charging device is used to receive the first signal and to control the switch to turn on an external charging power supply to charge the electronic device (Step 14). Alternatively, when the electric quantity of the battery is detected to be higher than a second amount, a second signal indicating a message of stopping the charging operation is generated (Step 15). Next, the second signal is transmitted through a USB interface (Step 16). Then, the USB control chip disposed in the charging device is used to receive the second signal and to control the switch to turn off the external charging power supply to stop charging the electronic device (Step 17).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A charging system for an electronic device, applicable for controlling an external charging power supply to charge the electronic device, comprising:
an electric quantity detection software, running on the electronic device, for generating a first signal indicating a message of performing a charging operation when the electric quantity of a battery of the electronic device is detected to be lower than a first amount, or generating a second signal indicating a message of stopping the charging operation when the electric quantity of the battery is detected to be higher than a second amount;
a Universal Serial Bus (USB) interface, disposed in the electronic device, for outputting the first signal or the second signal; and
a charging device, connected to the USB interface, and having a USB control chip and a switch, wherein the USB control chip is used to receive the first signal and to control the switch to turn on the external charging power supply to charge the electronic device, or to receive the second signal and to control the switch to turn off the external charging power supply to stop charging the electronic device.

2. A charging method for an electronic device, applicable for controlling an external charging power supply to charge the electronic device, comprising:
using an electric quantity detection software running on the electronic device to detect the electric quantity of a battery of the electronic device;
transmitting a first signal indicating a message of performing a charging operation through a USB interface when the electric quantity of the battery is detected to be lower than a first amount;
transmitting a second signal indicating a message of stopping the charging operation through the USB interface when the electric quantity of the battery is detected to be higher than a second amount;
using a USB control chip disposed in a charging device to receive the first signal and to control the external charging power supply to perform a charging operation; and
using the USB control chip disposed in the charging device to receive the second signal and to control the external charging power supply to stop the charging operation.

3. The charging method for an electronic device as claimed in claim 2, wherein a switch is used to turn on the external charging power supply to charge the electronic device, or to turn off the external charging power supply to stop charging the electronic device.
